(19) United States
(12) Patent Application Publication
(10) Pub. No.: US 2025/0066685 A1
(43) Pub. Date: Feb. 27, 2025

(54) PROCESS FOR SEPARATING PLANT OIL FROM ONE OR MORE BIOREFINERY PROCESS COMPOSITIONS, AND RELATED COMPOSITIONS AND SYSTEMS

(71) Applicant: POET Research, Inc., Sioux Falls, SD (US)

(72) Inventors: Blake A. Schnell, Harrisburg, SD (US); Brady Christopher Clavel, Yankton, SD (US); Jacob A. Milbrandt, Tyndall, SD (US); Brett A. Flittie, Harrisburg, SD (US); Matthew J. Rindsig, Harrisburg, SD (US); Gregory George Fix, Yankton, SD (US)

(21) Appl. No.: 18/812,666

(22) Filed: Aug. 22, 2024

Related U.S. Application Data
(60) Provisional application No. 63/534,644, filed on Aug. 25, 2023.

(51) Int. Cl. C11B 1/06; B01D 25/12; B01D 36/04

(52) U.S. Cl. CPC C11B 1/06; B01D 25/12; B01D 36/04; B01D 2201/202

(57) ABSTRACT

Methods of separating plant oil from at least one biorefinery process composition. The methods include separating wet cake via one or more presses configured to separate wet cake into pressate and press cake. Optionally, a diluent can be used prior to separating wet cake in a press. Related biorefineries configured to separate wet cake via one or more presses into pressate and press cake.

### CROSS-REFERENCE TO RELATED APPLICATION

This nonprovisional patent application claims the benefit of U.S. Provisional Patent Application Ser. No. 63/534,644, filed on Aug. 25, 2023, wherein said provisional patent application is incorporated herein by reference in its entirety.

### BACKGROUND

The present disclosure relates to separating plant oil from one or more biorefinery process compositions.

There is a continuing need for improved methods and system for liberating and separating plant oil from one or more biorefinery process compositions.

### SUMMARY

The present disclosure includes embodiments of a method of separating plant oil from at least one biorefinery process composition. The method includes separating at least one biorefinery process composition via one or more screen devices into filtrate and retentate. The biorefinery process composition includes plant oil. At least one of the screen devices includes a screen having openings with a size of 250 micrometers or less. At least a portion of the biorefinery process composition flows through the openings and forms at least a portion of the filtrate. The retentate has a total solids content in a range from greater than 15% to less than 25% by weight based on the total weight of retentate on an as-is basis. The method also includes separating retentate via one or more solid-liquid separators into a liquid portion and wet cake. The wet cake has a total solids content in a range from 25% to 35% or less by weight based on the total weight of wet cake on an as-is basis. The method also includes separating wet cake via one or more presses configured to separate wet cake into pressate and press cake. The method also includes processing at least pressate, which includes plant oil.

The present disclosure also includes embodiments of a biorefinery. The biorefinery includes filtering system configured to separate at least one biorefinery process composition via one or more screen devices into filtrate and retentate. At least one of the screen devices includes a screen having openings with a size of 250 micrometers or less so that at least a portion of the at least one biorefinery process composition can flow through the openings and form at least a portion of the filtrate. The biorefinery also includes a separation system in fluid communication with the filtering system and configured to separate retentate via one or more solid-liquid separators into a liquid portion and wet cake. The biorefinery also includes a press system in fluid communication with the separation system and configured to separate wet cake via one or more presses into pressate and press cake. The biorefinery is configured to process at least pressate.

The present disclosure also includes embodiments of a method of separating plant oil from at least one biorefinery process composition. The method includes separating at least one biorefinery process composition via one or more screen devices into filtrate and retentate. The biorefinery process composition includes plant oil. At least one of the screen devices includes a screen having openings with a size of 250 micrometers or less. At least a portion of the biorefinery process composition flows through the openings and forms at least a portion of the filtrate. The retentate has a total solids content of 35% or less by weight based on the total weight of retentate on an as-is basis. The method also includes adding one or more diluents to the retentate to form a diluted retentate. The method also includes separating diluted retentate via one or more solid-liquid separators into a liquid portion and wet cake. The wet cake has a total solids content in a range from 25% to 35% or less by weight based on the total weight of wet cake on an as-is basis. The method also includes separating wet cake via one or more presses configured to separate wet cake into pressate and press cake. The method also includes processing at least pressate, wherein the pressate comprises plant oil.

The present disclosure also includes embodiments of a biorefinery. The biorefinery includes a filtering system configured to separate at least one biorefinery process composition via one or more screen devices into filtrate and retentate. At least one of the screen devices includes a screen having openings with a size of 250 micrometers or less so that at least a portion of the at least one biorefinery process composition can flow through the openings and form at least a portion of the filtrate. The biorefinery is configured to add one or more diluents to the retentate to form a diluted retentate. The biorefinery also includes a separation system in fluid communication with the filtering system and configured to separate diluted retentate via one or more solid-liquid separators into a liquid portion and wet cake. The biorefinery also includes a press system in fluid communication with the separation system and configured to separate wet cake via one or more presses into pressate and press cake. The one or more presses include a rotatable screw disposed within a rigid housing. The rigid housing includes a plurality of openings. One or more presses are configured to rotate the rotatable screw to convey wet cake through the rigid housing under pressure so that wet cake presses against the rigid housing to separate wet cake into pressate and press cake. The biorefinery is configured to process at least pressate.

### BRIEF DESCRIPTION OF THE DRAWINGS

Various examples of the present disclosure will be discussed with reference to the appended drawings. These drawings depict only illustrative examples of the disclosure and are not to be considered limiting of its scope.

FIG. 1 shows a process-flow diagram of a non-limiting embodiment of a biorefinery configured to separate plant oil from at least one biorefinery process composition using a pretreatment system and at least one press;

FIG. 2 shows a process-flow diagram of a non-limiting embodiment of a biorefinery configured to separate plant oil from whole stillage using a pretreatment system and screw press;

FIG. 3 shows a process-flow diagram of a non-limiting embodiment of a biorefinery configured to separate plant oil from whole stillage using a pretreatment system and screw press;

FIG. 4 shows a process-flow diagram of a non-limiting embodiment of a biorefinery configured to separate plant oil from whole stillage using a pretreatment system and screw press;

FIG. 5A shows a process-flow diagram of a non-limiting embodiment of a corn ethanol biorefinery configured to separate corn oil from whole stillage using a pretreatment system and screw press;

FIG. 5B shows a process-flow diagram of a non-limiting embodiment of the corn oil separation system shown in FIG. 5A;

FIG. 6A shows a non-limiting example of a dewatering screw press;

FIG. 6B shows a non-limiting example of a screw rotor used in the dewatering screw press shown in FIG. 6A; and

FIG. 7 shows compositional data of biorefinery process compositions formed using an embodiment similar to FIG. 2 in the Example below.

### DETAILED DESCRIPTION

The present disclosure relates to processing a biorefinery process composition prior to exposing a composition derived therefrom to one or more presses to liberate oil from one or more materials such that oil can subsequently be separated and, e.g., formed into an oil product. A non-limiting example of methods and systems for liberating and separating oil from a biorefinery process composition is described in U.S. Pat. No. 10,584,304 (Schnell et al.), wherein the entirety of said patent is incorporated herein by reference.

Oil may be physically and/or chemically bound with plant components (e.g., fiber, protein, and/or carbohydrates) and exposing a process stream to one or more presses can work to free oil from those components so that the oil can be subsequently separated into one or more process streams. According to the present disclosure, a biorefinery process composition can be processed in a pretreatment system to adjust the “pressability” of the biorefinery process composition and form a process stream having a desirably pressability as an input to one or more presses to help liberate oil. “Pressability” of an input stream that is fed to one or more presses can be impacted by one or more factors such as the total solids (percent by weight) of the feed stream to a press; the “fines” content that may be present in a feed stream to a press; one or more additives; combinations of these; and the like. “Fines” refer to fine insoluble particles of one or more of fiber, proteins, carbohydrates (e.g., starches, cellulose, etc.), and the like. In some embodiments, while not being bound by theory, it is believed that one or more of such types of particles may have one or more properties that change due to exposure to distillation conditions and that such changes may impact how a downstream feed stream into a press may be pressed. For example, one or more types of fines may be more challenging to press in a screw press depending on one or more of the process histories (e.g., pressure and/or thermal history) and composition (e.g., chemistry, total solids, etc.) of the feed to a screw press. In some embodiments, as the content of fines increases, blinding of a screen in a press such as a screw press screen may occur to an undue degree causing an interruption in continuous operation.

Non-limiting examples of additives that can impact the pressability of an input to a press such as a screw press include one or more enzymes (e.g., amylases, hemicellulases, cellulases, xylanases, combinations of these, and the like), one or more demulsifiers, and one or more pH adjusters (e.g., an acidic or basic additive).

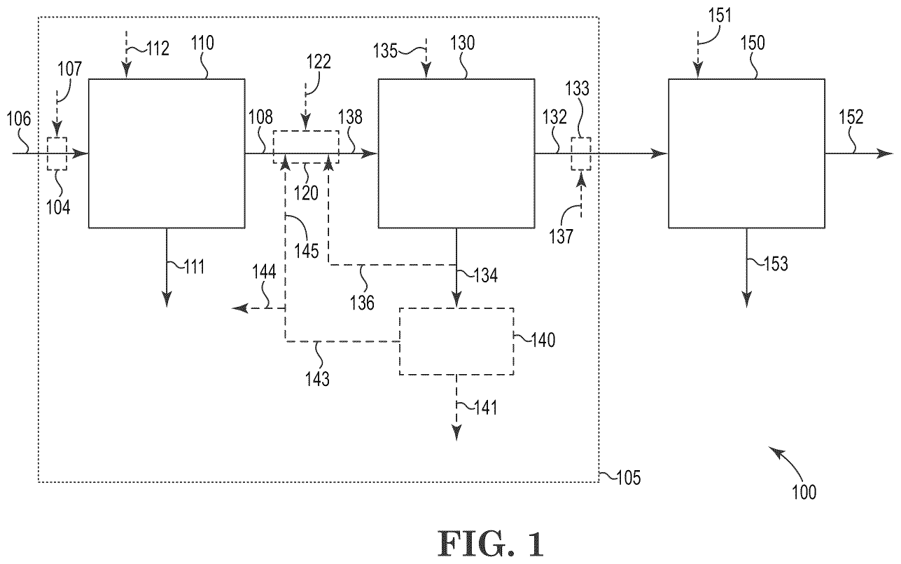

A non-limiting example of a method of separating plant oil from at least one biorefinery process composition according to the present disclosure is described below with reference to FIG. 1.

According to the present disclosure, a biorefinery process composition is produced at a biorefinery. As used herein, a biorefinery refers to a facility that can produce one or more bioproducts by converting plant-based feedstock via one or more physical processes, one or more chemical processes, one or more bioprocesses, and combinations thereof. Non-limiting examples of bioprocessing facilities include dry mills, wet mills, biofuel production facilities, soy processing facilities, and the like. A bioproduct refers to a product derived from a biological, renewable resource. For example, a bioproduct can be a component of plant-based feedstock that is liberated from the plant-based feedstock (e.g., corn oil from corn grain) and/or can include a chemical (“biochemical” or “target biochemical”) that is produced by a biocatalyst (e.g., microorganism and/or enzyme) such as, for example, alcohol produced by yeast fermenting sugar. Non-limiting examples of bioproducts produced in a biorefinery include one or more of fuel, feed, food, pharmaceuticals, beverages and precursor chemicals. In some embodiments, a bioproduct includes, among others, one or more monomeric sugars, one or more enzymes, one or more plant oils, one or more alcohols (e.g., ethanol, butanol, and the like), one or more biogases (e.g., methane), fungal biomass, amino acids, and one or more organic acids (e.g., lactic acid), and combinations thereof.

In some embodiments, a biorefinery process composition can include at least one composition to be used for fermentation and/or produced by fermentation (e.g., beer), at least one stillage composition, and combinations thereof.

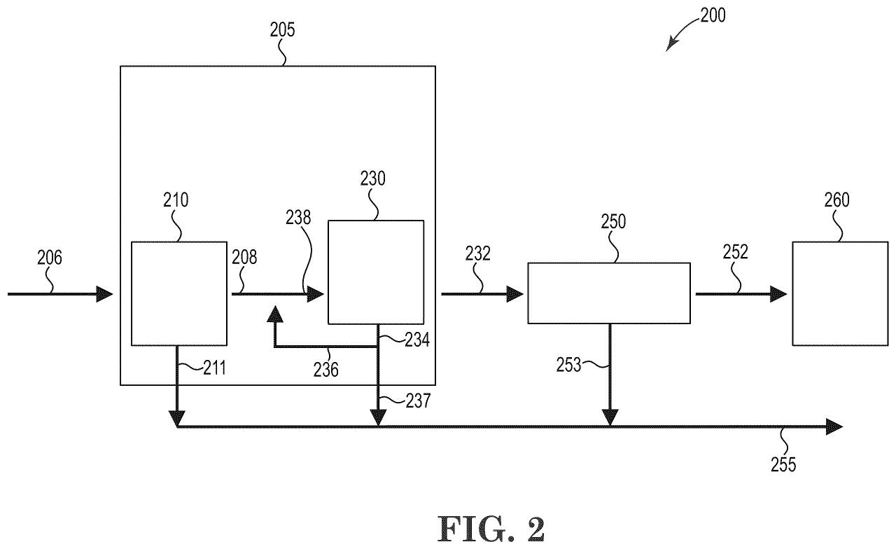

As used herein, a “stillage composition” refers to a back-end composition of a fermentation process after separating (e.g., via distillation) one or more bioproducts from beer to form at least one target bioproduct stream (e.g., ethanol) and one or more co-product streams (e.g., whole stillage). A stillage composition can include whole stillage, at least one stillage composition derived from whole stillage, and combinations thereof. In some embodiments, whole stillage is derived from distilling beer in a dry-grind corn ethanol process/biorefinery. Non-limiting examples of a stillage composition derived from whole stillage include thin stillage, concentrated thin stillage (syrup), defatted syrup, defatted emulsion, clarified thin stillage, distiller's oil, distiller's grain, distiller's yeast, and the like. Defatted syrup and defatted emulsion are examples of stillage compositions that remain after fat (e.g., corn oil) has been separated from syrup and emulsion, respectively, and can be referred to as “defatted stillage compositions.” Non-limiting illustrations showing one or more of the above-mentioned stillage compositions are shown in each of FIGS. 2-5B (discussed below). Non-limiting examples of methods and systems for processing stillage streams are also described in U.S. Pat. No. 8,702,819 (Bootsma); U.S. Pat. No. 9,061,987 (Bootsma); U.S. Pat. No. 9,290,728 (Bootsma); U.S. Pat. No. 10,059,966 (Bootsma); U.S. Pat. No. 11,248,197 (Bootsma); and U.S. Pub. No. 2020/0140899 (Bootsma); wherein the entirety of each of said patent documents is incorporated herein by reference. A stillage composition also includes back-end compositions of a fermentation process after separating one or more bioproducts from beer using separation technologies other than distillation (e.g., membrane separation, gas stripping, absorption).

A biorefinery process composition to be processed according to the present disclosure includes at least plant oil derived from a plant-based feedstock, and at least a portion of the plant oil can be liberated using one or more presses as described herein. A wide variety of plant-based feedstocks can be used according to the present disclosure such as grains and/or legumes. In some embodiments, a plant-based feedstock can include corn, sorghum, wheat, rice, barley, soybean, rapeseed, oats, millet, rye, and the like.

In addition to plant oil, a biorefinery process composition includes one or more additional materials such as one or more plant constituents and/or non-plant materials. Non-limiting examples of such additional materials include (e.g., plant protein (e.g., corn protein) and/or yeast protein from spent yeast cells), fiber, carbohydrate (e.g., cellulose, starch, and the like), vitamins, minerals, and combinations thereof.

As mentioned above, the pressability of an input process stream to a press to liberate oil can be influenced by the total solids content. Total solids is the sum of dissolved solids and suspended solids. Suspended solids refer to material (e.g., corn fiber particles, fat, and the like) that is not dissolved in water that is present in a biorefinery process composition. Non-limiting examples of suspended solids include at least one of plant fiber particles, one or more plant fats (plant oils), one or more proteins, and the like. Protein can include plant protein, cellular protein of one or more microorganisms that are present in a biorefinery process composition (e.g., spent yeast cells), and/or protein produced by one or more microorganisms that are present in a biorefinery process composition. Dissolved solids refer to material that is dissolved in water that is present in biorefinery process composition. Non-limiting examples of dissolved solids include at least one of one or more of proteins, one or more vitamins, one or more minerals, one or more saccharides, and the like. A non-limiting example of a dissolved protein includes water-soluble corn gluten protein.

Percent total solids, percent suspended solids, and percent dissolved solids are reported on an “as-is basis” since moisture is included to describe the degree of concentration of the solids. Components of a biorefinery process composition such as protein can be reported on an as-is or dry-weight basis. Unless noted otherwise, amounts are on a weight basis.

As mentioned above, a biorefinery process composition can be processed to adjust the “pressability” of the biorefinery process composition and form a process stream having a desirable pressability as an input to one or more presses to help liberate oil. For illustration purposes, FIG. 1 shows a biorefinery process composition 106 “processed” via pretreatment system 105 so that wet cake 132 has desirable pressability as an input to one or more presses 150 to help liberate oil. In some embodiments, a biorefinery process composition 106 has a total solids content of 15% or less by weight based on the total weight of the at least one biorefinery process composition on an as-is basis. In some embodiments, a biorefinery process composition 106 has a total solids content in a range from 10% to 14%, or even 11% to 13% by weight based on the total weight of the biorefinery process composition on an as-is basis.

Optionally, one or more streams 107 can be introduced into biorefinery process composition 106 to modify biorefinery process composition 106 chemically, thermally, and/or enzymatically to help liberate oil from one or more plant components as described herein. The one or more streams 107 can be combined with biorefinery process composition 106 via system 104 such as one or more inline static mixers, one or more tanks, one or more continuous stirred tank reactors (CSTRs), one or more heat exchangers, combinations of these, and the like. In some embodiments, the one or more streams 107 can include one or more additives such as acids, bases, or enzymes. In some embodiments, the one or more streams 107 can include relatively hot process streams to heat a heat exchanger in system 104. Non-limiting examples of hot process streams include thin stillage, distillate, side-stripper bottoms, evaporator condensate, combinations of these, and the like. Hot process streams can be at a temperature from 150° F. to 200° F., or even from 175° F. to 195° F.

As shown in FIG. 1, biorefinery process composition 106 is separated via one or more screen devices 110 into filtrate 111 (“thrus”) and retentate 108 (“overs”). The total solids content, suspended solids content, and dissolved solids content of retentate 108 can vary depending on, e.g., the biorefinery process composition 106 and/or the one or more screen devices 110. In some embodiments, the retentate 108 has a total solids content in a range from greater than 15% to 35% or less (e.g., less than 25%) by weight based on the total weight of retentate on an as-is basis. In some embodiments, the retentate has a total solids content in a range from 16% to 30%, from 16% to 25%, or even from 17% to 20% by weight based on the total weight of retentate on an as-is basis. In some embodiments, the retentate has a suspended solids content in a range from 15% to 25%, from 15% to 22%, or even from 16% to 18% by weight based on the total weight of retentate on an as-is basis. In some embodiments, the retentate has a dissolved solids content in a range from 1% to 5%, from 1% to 3%, or even from 1% to 2% by weight based on the total weight of retentate on an as-is basis. Similarly, the concentration of fat, fiber, ash, protein, and/or starch of retentate 108 can vary depending on, e.g., the biorefinery process composition 106 and/or the one or more screen devices 110. For example, fiber that may be present in the retentate 108 can vary depending on how much “fine” fiber and/or protein is separated into the filtrate 111. In some embodiments, the retentate has fat in a range from 5% to 20%, from 8% to 15%, or even from 9% to 14% on a dry weight basis (dwb). In some embodiments, the retentate has ash in a range from 0.5% to 10%, from 1% to 8%, or even from 1% to 5% on a dry weight basis (dwb). In some embodiments, the retentate has protein in a range from 15% to 45%, from 20% to 40%, or even from 25% to 35% on a dry weight basis (dwb). In some embodiments, the retentate has starch (e.g., residual starch) in a range from 0.5% to 10%, from 1% to 8%, or even from 1% to 7% on a dry weight basis (dwb).

The total solids content, suspended solids content, and dissolved solids content of filtrate 111 can similarly vary depending on, e.g., the biorefinery process composition 106 and/or the one or more screen devices 110. In some embodiments, the filtrate 111 has a total solids content in a range from 6% to 12%, from 7% to 11%, or even from 8% to 10% by weight based on the total weight of filtrate on an as-is basis. In some embodiments, the filtrate has a suspended solids content in a range from 4% to 8%, from 5% to 7%, or even from 5% to 6% by weight based on the total weight of filtrate on an as-is basis. In some embodiments, the filtrate has a dissolved solids content in a range from 2% to 4% by weight based on the total weight of filtrate on an as-is basis. Similarly, the concentration of fat, fiber, ash, protein, and/or starch of filtrate 111 can vary depending on, e.g., the biorefinery process composition 106 and/or the one or more screen devices 110. For example, fiber may be present in the filtrate 111 can vary depending on how much “fine” fiber and/or protein is separated into the filtrate 111. In some embodiments, the filtrate has fat in a range from 15% to 35%, from 16% to 34%, or even from 17% to 33% on a dry weight basis (dwb). In some embodiments, the filtrate has ash in a range from 5% to 15%, from 6% to 14%, or even from 7% to 13% on a dry weight basis (dwb). In some embodiments, the filtrate has protein in a range from 15% to 45%, from 20% to 40%, or even from 25% to 35% on a dry weight basis (dwb). In some embodiments, the filtrate has starch (e.g., residual starch) in a range from 1% to 6%, from 1% to 5%, or even from 1% to 4% on a dry weight basis (dwb).

The one or more screen devices 110 can be described as a filtering system in fluid communication with a source of a biorefinery process composition 106 and configured to receive and separate the biorefinery process composition 106 into retentate 108 and filtrate 111. For example, the one or more screen devices 110 may be coupled to a distillation system (not shown) to receive whole stillage from the distillation system.

A screen device can be selected based the ability to facilitate providing a wet cake 132 having a desirably pressability (discussed above) for the one or more presses 150. For example, a screen device can be selected based on the ability to separate at least a portion of fines from the biorefinery process composition 106 into filtrate 111 to reduce the total amount of fines that are in retentate 108 as compared to biorefinery process composition 106. In some embodiments, one or more screen devices can classify fines (solid particles) present in biorefinery process composition 106 based on particle size to separate the fines from larger particles that have trapped oil, which can be separated, at least in part, in the one or more presses 150 (discussed below). A screen device can be selected based on energy usage which can impact carbon intensity (CI); maintenance; etc.

Non-limiting examples of a screen device include a gravity screen, a pressure screen, a paddle screen, and the like. An example of a gravity screen is referred to as a “DSM” screen. A DSM screen is also called a Dutch State Mines screen or sieve bend screen, and includes a curved concave wedge bar type of stationary screen. A feed stream is fed at the top of a DSM screen and flows down the curved surface due to gravity and allows liquid and particles that fit through the screen openings to be separated from the feed stream. A DSM screen can be configured to have a wide variety of arc angles such as 45°, 60°, 120°, 270°, and 300°. A pressure screen is another type of screen that is curved (e.g., having a 120° arc) and enclosed in a housing along with one or more nozzles. Each nozzle sprays a pressurized feed stream through the nozzle and onto the screen at a tangent so the feed stream flows down the curved screen so that liquid and particles that fit through the screen openings are separated from the feed stream. The feed stream can be pressurized as desired, e.g., from 20 to 100 psig, or even from 40 to 80 psig. Non-limiting examples of pressure screens are commercially available under the tradenames PS-Single pressure screen and PS-Triple pressure screen from Fluid-Quip, Inc.

A paddle screen includes a housing that encloses a horizontal, cylindrical screen within which a plurality of paddle bars rotate. A feed stream is fed (pumped or gravity fed) through the an inlet and pressed against the screen by the rotating paddles. Water and particles smaller than the screen openings pass through the screen while solid particles larger than the screen openings are retained on the screen surface and scraped off of the screen surface by rakes to a discharge port. A non-limiting example of a commercially available paddle screen is available under the tradename FQ-PS32 from Fluid-Quip, Inc.

A fiber filter includes a flexible, bag-like, filter sleeve that is coupled to a frame with a plurality of paddles disposed inside the mounted filter sleeve so that a feed stream can be pumped to the interior of the filter sleeve while the paddles rotate agitate the feed material and “fling” the feed material against the filter sleeve so that water and particles smaller than the filter sleeve openings pass through the filter sleeve while solid particles larger than the screen openings are retained inside the filter sleeve. The paddles can be oriented horizontally and coupled to a rotor that is configured to rotate by a motor. The rotor can also include one or more flights (e.g., ribbon flighting) that are configured to urge or push solid material retained inside the filter sleeve toward a discharge port near an end of the filter sleeve. The rotor can be configured to pulse feed stream material within the filter sleeve radially outwardly against the filtering sleeve. The filtering sleeve can be assembled or otherwise coupled to a frame via one or more supports. The one or more supports can be elastic and can permit the filtering sleeve to expand and contract along a longitudinal axis thereof. The one or more supports can be adjusted and tensioned by one or more adjustment devices.

In some embodiments, the filter sleeve may be vibrated, e.g., at high frequency. For example, vibration of the filter sleeve can be accomplished by (1) tensioning the filter sleeve with one or more springs attached to rigid structure of the fiber filter (2) rotating the rotor at a high-speed to induce pulsed waves in the feed stream, or (3) a combination thereof. The pulsing and/or vibrations can also force or otherwise urge liquid through the filter sleeve. The filter sleeve can be made of one or more natural or polymer fabrics. A polymer fabric can be made from one or more polymers chosen from, but is not limited to, polyester, polyether ether ketone (PEEK), or other suitable polymers. A natural or polymer fabric can be a woven or non-woven fabric. Any type of weave can be used to produce a filter sleeve composed of a woven fabric. Illustrative types of weaves can include plain weave, twill weave, satin weave, basket weave, leno weave, and mock leno weave. The filter sleeve can be formed by connecting opposing edges of a filter sleeve by a lap or double hook joint.

A fiber filter may include one or more of wiping elements, agitating elements, and one or more washing nozzles. For example, it may include a washing nozzle that can be positioned to help backflush material build-up that can cause the fabric filter sleeve to become blinded.

Non-limiting examples of fiber filters are commercially available under the tradenames FF 6 fiber filter, FF 12 fiber filter, and FF 30 fiber filter from Vincent Corporation. A non-limiting example of a fiber filter is described in U.S. Pat. No. 6,117,321 (Johnston), wherein the entirety of said patent is incorporated herein by reference.

Non-limiting examples of screen devices are also described in U.S. Pub. No. 2020/0140899 (Bootsma), wherein the entirety of said patent application publication is incorporated herein by reference.

A screen device can include a screen or filter having a wide range of opening sizes. The opening sizes of a screen or filter among two more screen devices (e.g., in series or indirectly in fluid communication in the same process flow) can be the same or different. For example, a first screen device can have a screen or filter with opening sizes that are larger as compared to a downstream, second screen device, or vice versa. In some embodiments, one or more screen devices has a screen or filter with a openings with a size of 750 micrometers or less, 700 micrometers or less, 650 micrometers or less, 600 micrometers or less, 550 micrometers or less, 500 micrometers or less, 450 micrometers or less, 400 micrometers or less, 350 micrometers or less, 300 micrometers or less, 250 micrometers or less, 200 micrometers or less, 150 micrometers or less, 100 micrometers or less, 50 micrometers or less, or even 25 micrometers or less. For example, one or more screen devices has a screen or filter with openings having a size in a range from 50 to 225 micrometers, from 100 to 225 micrometers, from 125 to 200 micrometers, or even from 140 to 170 micrometers.

Optionally, a biorefinery process composition 106 can be dewatered (not shown) prior to separating the biorefinery process composition via one or more screen devices 110 into filtrate 111 and retentate 108. Dewatering the biorefinery process composition 106 can help adjust the total solids content of the biorefinery process composition 106 prior to being exposed to one or more screen devices 110. Non-limiting examples of devices and systems that can dewater biorefinery process composition 106 include one or more of decanters, disk stack centrifuges, screens, filters, hydrocyclones, evaporators, combinations of these and the like.

Optionally, one or more streams 112 can be introduced into biorefinery process composition 106 while the biorefinery process composition 106 is being separated via one or more screen devices 110. The one or more streams 112 can treat biorefinery process composition 106 chemically, thermally, and/or enzymatically to help liberate oil from one or more plant components as described herein. In some embodiments, one or more streams 112 can include one or more additives such as acids, bases, or enzymes.

According to one aspect of the present disclosure, pretreatment system 105 includes at least one additional separation to adjust total solids and/or remove additional fines from retentate 108 and provide wet cake 132 having desirable pressability. For example, the biorefinery process composition can be separated via one or more screen devices 110 into retentate 108 having a total solids content in a range from greater than 15% to less than 25% by weight based on the total weight of retentate. In some embodiments, as shown in FIG. 1, the retentate 108 may be separated directly using one or more solid-liquid separators 130 into a liquid portion 134 and wet cake 132, where the wet cake has a total solids content in a range from 25% to 35% or less by weight based on the total weight of wet cake on an as-is basis. Advantageously, pretreatment system 105 having such a configuration can increase the total solids in wet cake 132 while decreasing the fines (suspended particles) content further and separating oil at the same time. The pretreatment system 105 can provide wet cake 132 with desirable “pressability” for one or more presses 150 to help transfer oil from the wet cake 132 into a pressate 153, or press liquid (discussed below).

Optionally, one or more streams 122 can be introduced into retentate 108 to modify retentate 108, e.g., chemically, thermally, and/or enzymatically to help liberate oil from one or more plant components as described herein. The one or more streams 122 can be combined with retentate 108 via system 120 such as one or more inline static mixers, one or more tanks, one or more continuous stirred tank reactors (CSTRs), one or more heat exchangers, combinations of these, and the like. In some embodiments, one or more streams 122 can function as a diluent and/or wash liquid, as described below. In some embodiments, the one or more streams 122 can include one or more additives such as acids, bases, or enzymes. Advantageously, because of the volume reduction from biorefinery process composition 106 to retentate 108 the one or more additives may be more effective in a reduced amount. In some embodiments, the one or more streams 122 can include relatively hot process streams to heat a heat exchanger in system 120. Non-limiting examples of hot process streams to heat a heat exchanger include thin stillage, distillate, side-stripper bottoms, evaporator condensate, combinations of these, and the like. Hot process streams can be at a temperature from 150° F. to 200° F., or even from 175° F. to 195° F.

According to another aspect of the present disclosure, the retentate 108 may have a total solids content that makes it challenging to transport the retentate 108 downstream to one or more solid-liquid separators 130 in pretreatment system 105. For example, one or more screen devices 110 may produce a retentate 108 having a reduced fines content as compared to biorefinery process composition 106. But, the total solids content of retentate 108 may be too high to be pumped (e.g., in a centrifugal pump) and too low to be conveyed on a conveyor to one or more solid-liquid separators 130. The total solids of retentate 108 can optionally be adjusted by adding one or more diluents to the retentate 108 and form a diluted retentate 138 that can be transported to additional equipment in pretreatment system 105 for adjusting pressability. In some embodiments, retentate 108 can have a total solids content of up to 35% by weight based on the total weight of retentate. One or more diluents can be added to retentate 108 and form a diluted retentate 138 having reduced total solids and that is relatively more pumpable.

According to another aspect of the present disclosure, advantage can be taken of the volume reduction from biorefinery process composition 106 to retentate 108 so that, in addition to decreasing the total solids content of retentate 108 for transportability as discussed above, a diluent can also function as a wash liquid to facilitate “displacement washing” retentate 108 to enhance the separation of fine particles (fines) and/or oil in one or more solid-liquid separators 130.

A wide variety of diluents can be added to retentate. Non-limiting examples of process streams that can be used as a diluent include fresh water, one or more process streams from one or more locations in a biorefinery, and combinations thereof. Non-limiting examples of one or more process streams from one or more locations in biorefinery include one or more stillage compositions (e.g., thin stillage), distillate, side-stripper bottoms, evaporator condensate, combinations of these, and the like. Additional non-limiting examples of process streams that can function as a diluent include portion 136 and portion 145, each of which are discussed below. In some embodiments, relatively hot process streams can facilitate washing oil from retentate 108. Hot process streams such as one or more stillage compositions (e.g., thin stillage, distillate, side-stripper bottoms, and evaporator condensate) can be at a temperature from 150° F. to 200° F., or even from 175° F. to 195° F.

In some embodiments, a diluent can reduce the total solids of retentate 108 from 25% to 35% to less than 25% by weight based on the total weight of the retentate on an as-is basis. As another example, a diluent can reduce the total solids of retentate 108 from 17% to 19% to a range from 15% to less than 17% by weight based on the total weight of the retentate on an as-is basis. As another example, a diluent can reduce the total solids of retentate 108 from 17% to 20% to a range from 8% to less than 15%, or even from 8% to 10% by weight based on the total weight of the retentate on an as-is basis.

As mentioned above, retentate 108 can be further processed in pretreatment system 105 by being separated directly using one or more solid-liquid separators 130 into a liquid portion 134 and wet cake 132. Alternatively, if the retentate 108 is diluted first with a diluent to form a diluted retentate 138, then the diluted retentate 138 is separated using one or more solid-liquid separators 130 into a liquid portion 134 and wet cake 132.

The total solids content, suspended solids content, and dissolved solids content of wet cake 132 can vary depending on, e.g., the retentate 108 (or diluted retentate 138) and/or the one or more solid-liquid separators 130. In some embodiments, the wet cake 132 has a total solids content in a range from 25% to 35% or less, from 20% to 30%, from 22% to 28%, or even 25% to 30% by weight based on the total weight of wet cake on an as-is basis. Similarly, the concentration of fat, fiber, ash, protein, and/or starch of wet cake 132 can vary depending on, e.g., the retentate 108 (or diluted retentate 138) and/or the one or more solid-liquid separators 130. For example, fiber present in the wet cake 132 can vary depending on how much “fine” fiber and/or protein is separated into the liquid portion 134. Although the total amount of one or more water-soluble components and/or fine particles may be reduced in wet cake 132 as compared to retentate 108 (or diluted retentate 138), because at least a portion of one or more water-soluble components and/or fine particles are separated into liquid portion 134, the ranges of one or more concentrations of such materials may overlap among retentate 108 (or diluted retentate 138) and wet cake 132. In some embodiments, the wet cake has fat in a range from 5% to 20%, from 8% to 15%, or even from 9% to 14% on a dry weight basis (dwb). In some embodiments, the wet cake has ash in a range from 0.5% to 10%, from 1% to 8%, or even from 1% to 5% on a dry weight basis (dwb). In some embodiments, the wet cake has protein in a range from 15% to 45%, from 20% to 40%, or even from 25% to 35% on a dry weight basis (dwb). In some embodiments, the wet cake has starch (e.g., residual starch) in a range from 0.5% to 10%, from 1% to 8%, or even from 1% to 7% on a dry weight basis (dwb).

The total solids content, suspended solids content, and dissolved solids content of liquid portion 134 can similarly vary depending on, e.g., the composition of retentate 108 (or diluted retentate 138) and/or the configuration of the one or more solid-liquid separators 130. In some embodiments, the liquid portion 134 has a total solids content in a range from 2% to 10%, or even from 4% to 8% by weight based on the total weight of liquid portion on an as-is basis. In some embodiments, the liquid portion 134 has a suspended solids content in a range from 1% to 5%, or even from 2% to 4% by weight based on the total weight of liquid portion on an as-is basis. In some embodiments, the liquid portion has a dissolved solids content in a range from 1% to 5%, or even from 2% to 4% by weight based on the total weight of liquid portion on an as-is basis. Similarly, the concentration of fat, fiber, ash, protein, and/or starch of liquid portion 134 can vary depending on, e.g., the retentate 108 (or diluted retentate 138) and/or the one or more solid-liquid separators 130. For example, fiber that may be present in the liquid portion 134 can vary depending on how much “fine” fiber and/or protein is separated into the wet cake 132. In some embodiments, the liquid portion has fat in a range from 15% to 35%, from 16% to 34%, or even from 17% to 33% on a dry weight basis (dwb). In some embodiments, the liquid portion has ash in a range from 10% to 30%, from 12% to 28%, or even from 14% to 26% on a dry weight basis (dwb). In some embodiments, the liquid portion has protein in a range from 15% to 45%, from 20% to 40%, or even from 25% to 35% on a dry weight basis (dwb). In some embodiments, the liquid portion has starch (e.g., residual starch) in a range from 4% to 12%, from 6% to 10%, or even from 7% to 9% on a dry weight basis (dwb).

As mentioned above, optionally one or more diluents can be added to retentate 108 to help adjust the total solids and/or separating oil via displacement washing. Although other process streams in biorefinery 100 could be used as diluent, for illustration purposes, at least a portion 136 of liquid portion 134 can optionally (as shown by dashed lines in FIG. 1) be recycled and added to retentate 108 as a diluent to form diluted retentate. In some embodiments, liquid portion 134 may be more desirable than filtrate 111 as a diluent because liquid portion 134 may have less fines as compared to filtrate 111. Because one or more process streams in biorefinery 100 may have fines, a process stream can be clarified to remove at least a portion of fines (suspended solids) and form a more desirable diluent to add to retentate 108. Again, for illustration purposes, suspended solid particles 141 can optionally (as shown by dashed lines in FIG. 1) be separated from liquid portion 134 via a clarifying system 140 to form a clarified, liquid portion 143. At least a portion 145 of clarified, liquid portion 143 can be added to retentate 108 as a diluent. If desired, at least a portion 144 of clarified, liquid portion 143 can be used for another purpose such as back set at the front end of a dry-grind corn ethanol biorefinery.

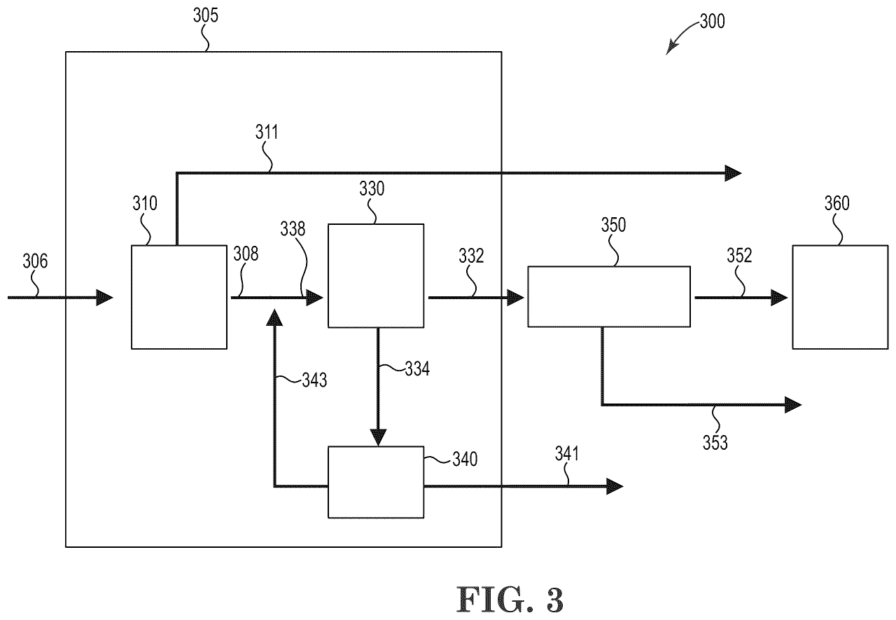

Clarifying system 140 can include one or more one or more centrifuges (e.g., two-phase vertical disk-stack centrifuge, three-phase vertical disk-stack centrifuge, filtration centrifuge), one or more decanters (e.g., filtration decanters), and combinations thereof. Non-limiting examples of a clarifying system 140 is illustrated in FIG. 3 below.

The one or more solid-liquid separators 130 can be described as a separation system in fluid communication with the one or more screen devices 110 (a filtering system) and configured to separate retentate via one or more solid-liquid separators into a liquid portion 134 and wet cake 132.

A solid-liquid separator can be selected based on the ability to provide a wet cake 132 having a desirable pressability (discussed above) for the one or more presses 150. For example, a solid-liquid separator can be selected based on the ability to increase the total solids in the wet cake 132 as compared to retentate 108. As another example, a solid/liquid separator can also be selected based on the ability to separate at least a portion of fines from the retentate 108 into liquid portion 134 to reduce the total amount of fines that are in wet cake 132 as compared to retentate 108. A solid-liquid separator can be selected based on energy usage which can impact carbon intensity (CI)); maintenance; etc.

Non-limiting examples of solid-liquid separators include one or more centrifuges (e.g., two-phase vertical disk-stack centrifuge, three-phase vertical disk-stack centrifuge, filtration centrifuge), one or more decanters (e.g., filtration decanters), one or more filters (e.g., fiber filter, rotary vacuum drum filter, filter device having one or more membrane filters), one or more screen devices (e.g., a “DSM” screen; one or more pressure screens; one or more paddle screens; one or more rotary drum screens; one or more centrifugal screeners; one or more linear motion screens; one or more vacu-deck screen; etc.), one or more brush strainers, one or more vibratory separators, one or more hydrocyclones, and combinations thereof.

Optionally, one or more streams 135 can be introduced into retentate 108 or diluted retentate 138 while the retentate 108 or diluted retentate 138 is being separated via one or more solid-liquid separators 130. The one or more streams 135 can treat the retentate 108 or diluted retentate 138 chemically, thermally, and/or enzymatically to help liberate oil from one or more plant components as described herein. In some embodiments, the one or more streams 135 can include one or more additives such as acids, bases, or enzymes. It is noted that if one or more streams 135 are included, the wet cake 132 still has a total solids content, suspended solids content, dissolved solids content, etc. described above so that wet cake 132 has a desired pressability for one or more presses 150.

Optionally, one or more streams 137 can be introduced into wet cake 132 to modify wet cake 132 chemically, thermally, and/or enzymatically to help liberate oil from one or more plant components as described herein. The one or more streams 137 can be combined with wet cake 132 via system 133 such as one or more inline static mixers, one or more tanks, one or more continuous stirred tank reactors (CSTRs), one or more heat exchangers, combinations of these, and the like. In some embodiments, the one or more streams 137 can include one or more additives such as acids, bases, or enzymes. Advantageously, because of the volume reduction from retentate 108 or diluted retentate 138 to wet cake 132 the one or more additives may be more effective in a reduced amount. In some embodiments, the one or more streams 137 can include relatively hot process streams to heat a heat exchanger in system 133. Non-limiting examples of hot process streams include thin stillage, distillate, side-stripper bottoms, evaporator condensate, combinations of these, and the like. Hot process streams can be at a temperature from 150° F. to 200° F., or even from 175° F. to 195° F. It is noted that if one or more streams 137 are included, the wet cake 132 still has a total solids content, suspended solids content, dissolved solids content, etc. described above so that wet cake 132 has a desired pressability for one or more presses 150.

After pretreating a biorefinery process composition 106 in pretreatment system 105 to form a wet cake 132, the wet cake 132 can be separated via one or more presses 150 into at least press cake 152 and pressate 153. A press is configured to press wet cake against a surface having a plurality of openings so that a liquid portion can be squeezed from wet cake and form a pressate, thereby leaving a press cake remaining. Non-limiting examples of one or more presses 150 include one or more of a screw press, a filter press, an extruder, and the like. The one or more presses 150 can be described as a press system in fluid communication with the pretreatment system 105 (e.g., the one or more solid-liquid separators 130 in pretreatment system 105) and configured to separate wet cake 132 via one or more presses 150 into press cake 152 and pressate 153.

A screw press includes a rotatable screw disposed within a rigid housing. The rigid housing includes a plurality of openings so that when wet cake is pressed against the rigid housing a majority of the solids are retained inside the rigid housing and conveyed through the rigid housing to form press cake while liquid passes through the plurality of openings to form pressate. It is noted that the press cake can retain moisture present in the wet cake while the pressate may include dissolved and suspended solids. As the rotatable screw rotates it conveys wet cake through the rigid housing under pressure so that wet cake presses against the rigid housing to separate wet cake into pressate and press cake. A rotatable screw can include continuous or interrupted flighting on a screw rotor.

A non-limiting example of a press includes a screw press (also referred to as a “dewatering screw press”). One or more parameters can be selected to facilitate a desired oil yield from wet cake. Non-limiting examples of such parameters such as for a screw press include screen size, screw speed, backpressure, liquid injection, and screw design and configuration.

Non-limiting examples of screw presses are commercially available under the tradenames VP series screw presses, CP series screw presses, KP series screw presses, and TSP series screw presses from Vincent Corporation.

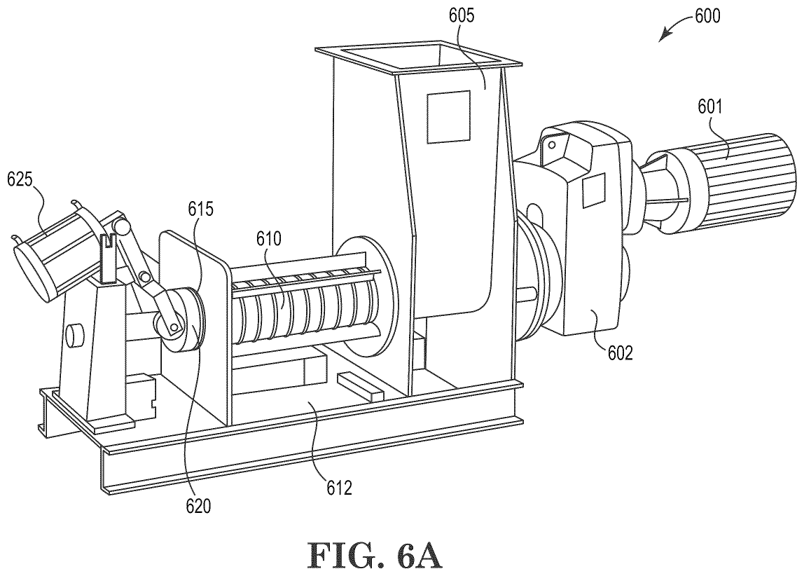

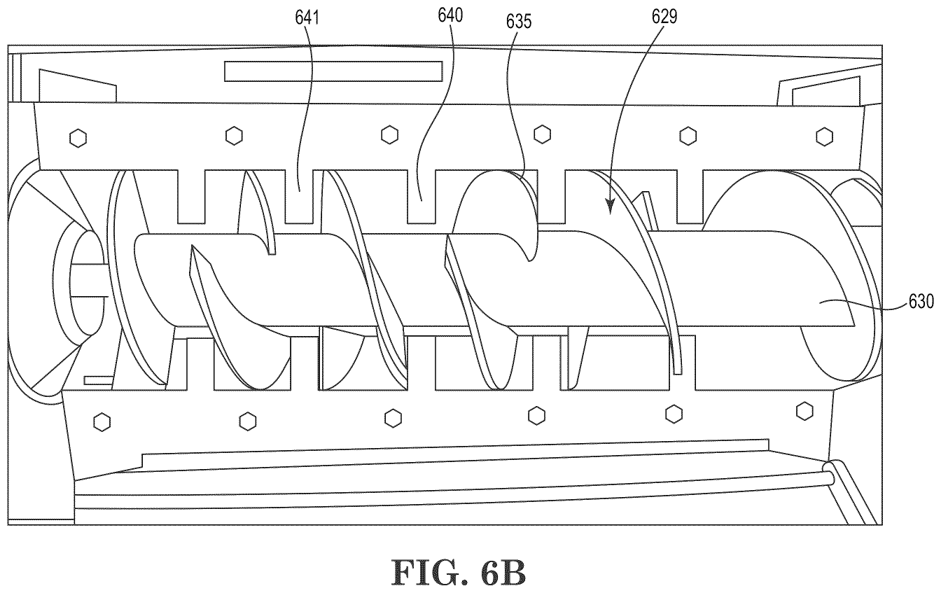

FIGS. 6A and 6B illustrate a non-limiting example of a lab-scale screw press 600 commercially available under the tradename CP4 screw press from Vincent Corporation. As shown in FIG. 6A, screw press 600 includes a motor 601 and gearbox 602, which is mechanically coupled to a rotatable screw 629 shown in FIG. 6B. Screw press 600 also includes a hopper 605 at an inlet end where wet cake can be fed into the screw press 600. The screw 629 is disposed inside rigid housing 610, which is a metal screen having a plurality of openings that functions as a filter. The rotatable screw 629 includes interrupted flighting 635 and screw rotor 630. As screw rotor 630 rotates it conveys wet cake through rigid housing 610 and toward discharge 615 while causing wet cake to press against rigid housing 610, thereby causing liquid to pass through rigid housing 610 and collect in pan 612.

Screw press 600 also includes a discharge cone 620 that can be set into discharge 615 under pressure by air cylinder 625. The pressure applied to discharge cone 620 by air cylinder 625 creates back pressure in wet cake present in rigid housing 610 and can control the moisture that is removed from wet cake. In some embodiments, air cylinder 625 can create a back pressure from 50 to 120 psig, from 50 to 115 psig, or even from 90 to 110 psig.

FIG. 6B shows the screw rotor 630 that is disposed within rigid housing 610 with the rigid housing 610 removed. As shown, the screw rotor 630 includes interrupted flighting 635 that can facilitate dewatering and moving of wet cake, and prevent co-rotation when used in combination with fixed teeth 640 and 641. While not being bound by theory, it is believed that the interrupted flighting 635 allows for material-on-material grinding in a manner that facilitates liberating trapped oil. While not being bound by theory, it is believed that the interrupted flighting 635 and fixed teeth such as teeth 640 and 641 create corresponding “dead” zones where wet cake temporarily accumulates under pressure and facilitates squeezing wet cake against rigid housing 610 to permit separating liquid including oil from wet cake into pressate.

Screw rotor 630 can rotate at an rpm to help liberate and transfer oil into the liquid that passes through the rigid housing 610. For example, screw rotor 630 can rotate during steady-state operations from 5 to 40 rpms, from 5 to 30 rpms, or even from 5 to 25 rpms.

The openings in a screen or filter of a press can blind to undue degree if the pressability of the wet cake is not appropriate. For example, fines and the like in wet cake can blind rigid housing 610 to an undue degree, necessitating stopping the continuous operation of the screw press 600 for a time period while the blinding is resolved. A pretreatment system according to the present disclosure can advantageously adjust the pressability of an input stream (e.g., whole stillage) so that the wet cake that is fed to a press (e.g., screw press) has a pressability that avoids undue blinding while liberating and separating trapped oil at the same time.

Optionally, referring back to FIG. 1, a wash liquid 151 can be introduced into wet cake 132 while separating wet cake 132 via one or more presses 150 into at least press cake 152 and pressate 153. Advantageously, because of the volume reduction from retentate 108 or diluted retentate 138 to wet cake 132, wash liquid 151 can facilitate “displacement washing” wet cake 132 to enhance separating oil. It is noted that if wash liquid 151 is included, the wash liquid should not impact the pressability, as discussed above, of wet cake 132 in one or more presses 150 to an undue degree.

A wide variety of wash liquids can be added to wet cake 132 while in one or more presses 150. Non-limiting examples of process streams that can be used as a wash liquid include fresh water, one or more process streams from one or more locations in a biorefinery, and combinations thereof. Non-limiting examples of one or more process streams from one or more locations in biorefinery include one or more stillage compositions (e.g., thin stillage), distillate, side-stripper bottoms, evaporator condensate, combinations of these, and the like. Additional non-limiting examples of process streams that can function as a wash liquid include portion 136 and portion 145, each of which are discussed above. In some embodiments, relatively hot process streams can facilitate washing oil from wet cake 132. Hot process streams such as one or more stillage compositions (e.g., thin stillage, distillate, side-stripper bottoms, and evaporator condensate) can be at a temperature from 150° F. to 200° F., or even from 175° F. to 195° F.

Biorefinery 100 is configured to process press cake 152 and pressate 153, as desired. For example, press cake 152 can be used as-is as an animal feed and/or fertilizer. Press cake 152 can also be dried in a dryer if desired. Pressate 153 can be further processed to separate plant oil and form a plant oil product. Pressate can be processed alone or combined with one or more other process compositions for further processing. For example, pressate 153 can be combined with at least a portion of filtrate 111 and/or at least a portion of liquid portion 134 so that the combined stream can be processed to separate plant oil into an oil product.

As mentioned above, wet cake 132 can be separated via one or more presses 150 into at least press cake 152 and pressate 153. If multiple presses are used in series, a wash liquid like wash liquid 151 can optionally be introduced into press cake between one or more successive pairs of presses in series. Again, it is noted that if wash liquid is introduced into press cake between one or more successive pairs of presses in series, the wash liquid should not impact the pressability, as discussed above, of press cake in the next press to an undue degree.

Non-limiting examples of configurations implementing pretreatment system 105 and one or more presses 150 shown in FIG. 1 are described herein below with respect to FIGS. 2-5B.

FIG. 2 shows whole stillage 206 in biorefinery 200 as an input to pretreatment system 205 to provide a wet cake 232 having desirable pressability for screw press 250 to liberate oil and transfer at least a portion of liberated oil into pressate 253.

In more detail, pretreatment system 205 includes a pressure screen 210 that separates whole stillage 206 into retentate 208 (overs) and filtrate 211 (thrus). Filtrate 211 separated from whole stillage 206 has relatively more liquid and less total solids than whole stillage 206 so it can also be referred to as thin stillage. The first separation in pretreatment system 205 with pressure screen 210 can help remove fines so as to improve the performance (pressability) of wet cake 232 that is fed to screw press 250. According to an aspect of the present disclosure, the pressability of retentate 208 may be adjusted prior to screw press 250 instead of feeding retentate directly to screw press 250. For example, the total solids in retentate 208 may not be high enough for a desired pressability in screw press 250. As another example, the fines in retentate 208 may be too high for a desired pressability in screw press 250 So, the retentate 208 is further processed in pretreatment system 205 using a decanter 230 to adjust the pressability (e.g., increase the total solids). At the same time, in some embodiments, the total solids in retentate 208 may be too high to pump and too low to convey the retentate 208 to decanter 230. According to another aspect of the present disclosure, as shown in FIG. 2, the retentate 208 is diluted with a portion 236 of centrate 234 to form diluted retentate 238 having reduced total solids, which is more pumpable than retentate 208. In addition to reducing the total solids of retentate 208, the portion 236 can function as a “wash” to enhance separation of additional fines and/or oil from diluted retentate 238 into centrate 234. Returning to decanter 230, the diluted retentate 238 is separated in decanter 230 into wet cake 232 and centrate 234. The remaining portion 237 of centrate 234 is added to filtrate 211. It is noted that the combined stream of portion 237 and filtrate 211 can also be referred to as thin stillage even though it is the product of two separations. The wet cake 232 is then processed in screw press 250 to liberate oil and separate wet cake 232 into press cake 252 and pressate 253. At least a portion of liberated plant oil can be transferred into pressate 253. As shown, the pressate 253 is added to the filtrate 211 and the remaining portion 237 of centrate 234 to form thin stillage 255. Thin stillage 255 would be expected to have a higher oil content as compared to thin stillage formed by separating the same whole stillage stream only though a decanter 230. The thin stillage 255 can be further processed. For example, if desired, the thin stillage 255 can be processed to separate plant oil and form an oil product. As shown, the press cake 252 can be dried in a dryer system 260 to form a product similar to DDGS.

FIG. 3 shows whole stillage 306 in biorefinery 300 as an input to pretreatment system 305 to provide a wet cake 332 having desirable pressability for screw press 350 to liberate oil and transfer at least a portion of liberated oil into pressate 353.

In more detail, pretreatment system 305 includes a pressure screen 310 that separates whole stillage 306 into retentate 308 and filtrate 311. The first separation in pretreatment system 305 with pressure screen 310 can help remove fines so as to improve the performance (pressability) in screw press 350. According to an aspect of the present disclosure, the pressability of retentate 308 may be adjusted prior to screw press 350 instead of feeding retentate 308 directly to screw press 350. For example, the total solids in retentate 308 may not be high enough for a desired pressability in screw press 350. As another example, the fines in retentate 308 may be too high for a desired pressability in screw press 350 So, the retentate 308 is further processed in pretreatment system 305 using a fiber filter 330 (instead of decanter 230 as in FIG. 2) to adjust the pressability (e.g., increase the total solids). At the same time, in some embodiments, the total solids in retentate 308 may be too high to pump and too low to convey the retentate 308 to fiber filter 330. According to another aspect of the present disclosure, as shown in FIG. 3, the retentate 308 is diluted with clarified filtrate 343 to form diluted retentate 338 having reduced total solids, which is more pumpable than retentate 308. In addition to reducing the total solids of retentate 308, the clarified filtrate 343 can function as a “wash” to enhance separation of additional fines and/or oil from diluted retentate 338 into filtrate 334. Returning to fiber filter 330, the diluted retentate 338 is separated in fiber filter 330 into wet cake 332 and filtrate 334. The filtrate 334 is clarified using a centrifuge as a clarifier 340 to separate fines from filtrate 334 into paste 341, thereby forming clarified filtrate 343. If desired, the paste 341 may be combined with press cake 352. The wet cake 332 is then processed in screw press 350 to liberate oil and separate wet cake 332 into press cake 352 and pressate 353. At least a portion of liberated plant oil can be transferred into pressate 353. If desired, the pressate 353 can be combined with filtrate 311 to form a thin stillage similar to thin stillage 255 discussed above with respect to FIG. 2. As shown, the press cake 352 can be dried in a dryer system 360 to form a product similar to DDGS.

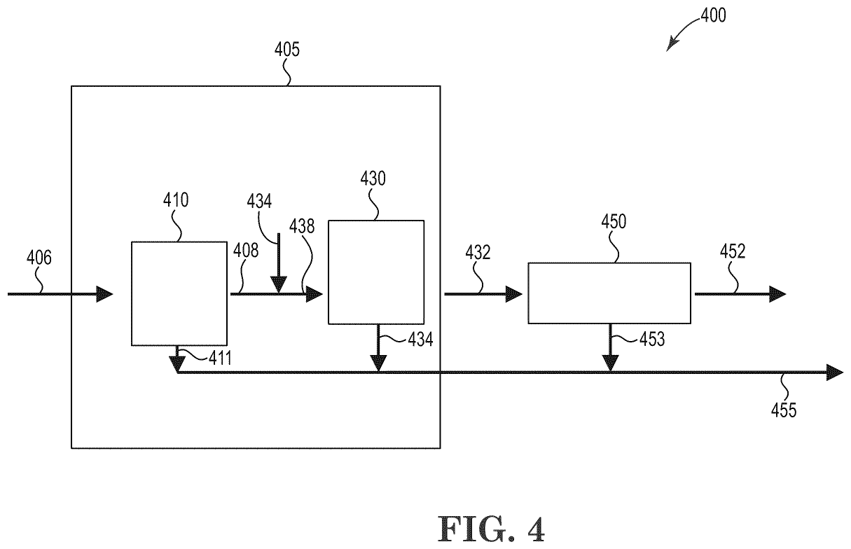

FIG. 4 shows whole stillage 406 in biorefinery 400 as an input to pretreatment system 405 to provide a wet cake 432 having desirable pressability for screw press 450 to liberate oil and transfer at least a portion of liberated oil into pressate 453.

In more detail, pretreatment system 405 includes a pressure screen 410 that separates whole stillage 406 into retentate (overs) 408 and filtrate (thrus) 411. The first separation in pretreatment system 405 with pressure screen 410 can help remove fines so as to improve the performance (pressability) in screw press 450. According to an aspect of the present disclosure, the pressability of retentate 408 may be adjusted prior to screw press 450 instead of feeding retentate directly to screw press 450. For example, the total solids in retentate 408 may not be high enough for a desired pressability in screw press 450. As another example, the fines in retentate 408 may be too high for a desired pressability in screw press 450. So, the retentate 408 is further processed in pretreatment system 405 using another pressure screen 430 (instead of decanter 230 as in FIG. 2 or fiber filter 330 in FIG. 3) to adjust the pressability (e.g., increase the total solids). At the same time, in some embodiments, the total solids in retentate 408 may be too high to pump and too low to convey the retentate 408 to pressure screen 430. According to another aspect of the present disclosure, as shown in FIG. 4, the retentate 408 is diluted with a diluent, such as filtrate 434 described below, to form diluted retentate 438 having reduced total solids, which may be more pumpable than retentate 408. In addition to reducing the total solids of retentate 408, the filtrate 434 can function as a “wash” to enhance separation of additional fines and/or oil from diluted retentate 438 into filtrate 434. Returning to pressure screen 430, the diluted retentate 438 is separated in pressure screen 430 into wet cake 432 and filtrate 434. It is noted that the screen opening sizes of pressure screen 410 may be the same or different than the screen opening sizes of pressure screen 430. The filtrate 434 is combined with filtrate 411. The wet cake 432 is then processed in screw press 450 to liberate oil and separate wet cake 432 into press cake 452 and pressate (pressate) 453. At least a portion of liberated plant oil can be transferred into pressate 453. As shown, the pressate 453 is combined with filtrate 411 and filtrate 434 to form a thin stillage 455 as similarly described above with respect to thin stillage 255 in FIG. 2. The press cake 452 can be used directly as an animal feed or fertilizer, or dried in a dryer system.

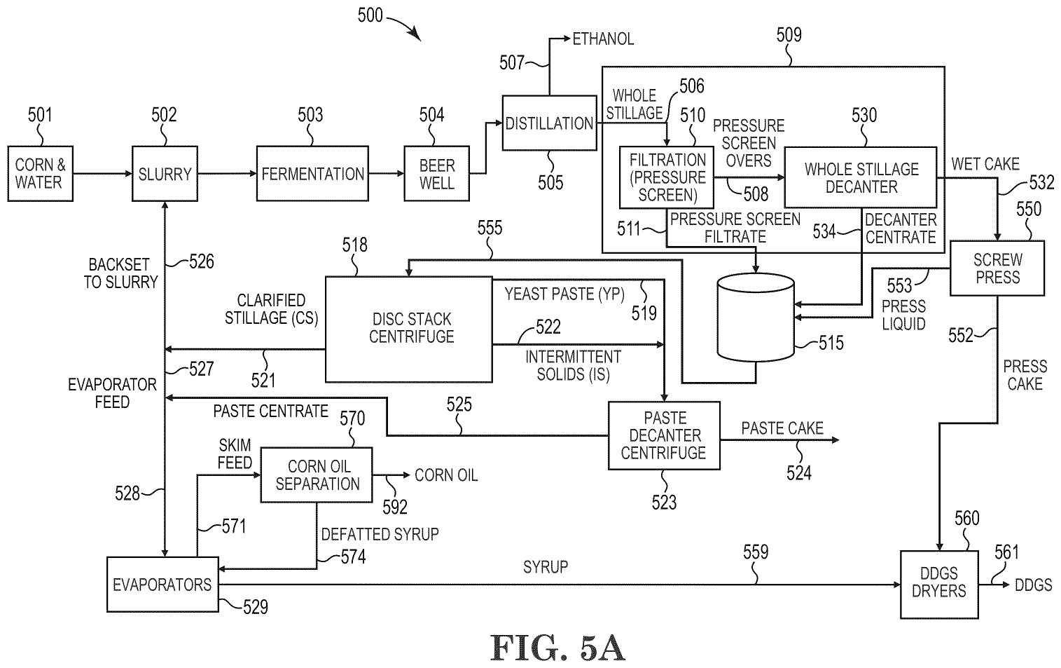

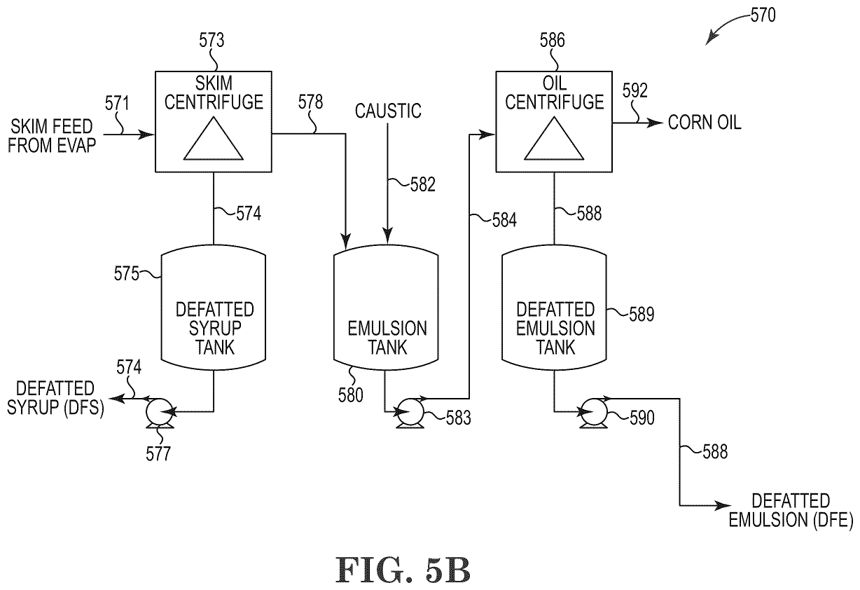

FIG. 5A illustrates an example of a dry-grind corn ethanol biorefinery as a biorefinery 500 that incorporates a pretreatment system 509 according to the present disclosure. The biorefinery 500 includes a “front end” and a “back end.” The front end includes distillation system 505 and upstream from distillation system 505. As shown in FIG. 5A, the front end starts with adding ground corn and water 501 to a slurry tank 502, which is fed to a fermentation system 503 that ferments sugars into a beer that includes ethanol and carbon dioxide. Beer is transferred to a beer well 504 and eventually to a distillation system 505 where ethanol 507 is separated from beer to form whole stillage 506.

Whole stillage 506 is fed to pretreatment system 509 to provide a wet cake 532 having desirable pressability for screw press 550 to liberate oil and transfer at least a portion of liberated oil into pressate 553.

In more detail, pretreatment system 509 includes a pressure screen 510 that separates whole stillage 506 into retentate (overs) 508 and filtrate (thrus) 511. The first separation in pretreatment system 509 with pressure screen 510 can help remove fines so as to improve the performance (pressability) in screw press 550. According to an aspect of the present disclosure, the pressability of retentate 508 may be adjusted prior to screw press 550 instead of feeding retentate directly to screw press 550. For example, the total solids in retentate 508 may not be high enough for a desired pressability in screw press 550. As another example, the fines in retentate 508 may be too high for a desired pressability in screw press 550 So, the retentate 508 is further processed in pretreatment system 509 using a decanter 530 to adjust the pressability (e.g., increase the total solids). The decanter 530 separates retentate 508 into wet cake 532 and centrate 534. The wet cake 532 is then processed in screw press 550 to liberate oil and separate wet cake 532 into press cake 552 and pressate 553. At least a portion of liberated plant oil can be transferred into pressate 553. As shown, the pressate 553 is combined with filtrate 511 and centrate 534 to form thin stillage 555 in tank 515. By using the configuration shown in FIG. 5, the thin stillage 555 has a relatively higher fat content and fine, suspended solids content as compared to if the whole stillage 506 is separated into thin stillage using only whole stillage decanter 530 and no pressure screen 510 and/or no screw press 550. The thin stillage 555 is clarified prior to formation of corn oil product 592. The press cake 552 is dried in dryer system 560 to form dried distillers' grain (DDGS) 561.

The thin stillage 555 is transferred to a vertical, disk stack centrifuge 518 that separates the thin stillage 555 into a light-phase discharge stream (clarified stillage (CS)) 521, and a heavy-phase discharge stream (yeast paste (“YP”)) 519. Intermittently, accumulated solids are discharged as intermittent solids (“IS”) 522 and combined with the yeast paste stream 519. The intermittent solids 522 and yeast paste 519 streams are provided directly to a horizontal paste decanter 523 to form a paste cake 524 and a paste centrate 525.

A portion 526 of the clarified stillage stream 521 is transferred to the slurry tank 502 as backset, while the rest 527 of the clarified stillage stream 521 is combined with the paste centrate 525 to form evaporator feed 528, which is transferred to an evaporator train 529 that may include 4 to 8 evaporators in series (depending on plant size) to remove water and form syrup 559. Prior to reaching the end of the evaporator train 529, a semi-concentrated syrup (“skim feed”) 571 is removed and sent to corn oil separation system 570 which removes corn oil product 592.

The corn oil separation system 570 is described in more detail in FIG. 5B. As shown in FIG. 5B, the skim feed 571 is separated in a “skim” centrifuge 573 into an emulsion 578 and defatted syrup 574. The defatted syrup 574 can accumulate in defatted syrup tank 575 and defatted syrup 574 is eventually returned to the evaporator train 529 via pump 577, where a syrup 559 (FIG. 5A) is sent as a final syrup to dryer system 560 to form DDGS 561 as shown in FIG. 5B. The emulsion 578 is combined with caustic 582 in emulsion tank 580 to help “break” the emulsion into an oil phase and aqueous phase that are more easily separated from each other. The treated emulsion 584 is pumped via pump 583 to oil centrifuge 586, wherein the treated emulsion 584 is separated into a corn oil product 592 and defatted emulsion 588. The defatted emulsion 588 can accumulate in defatted emulsion tank 589 and defatted emulsion 588 can be pumped via pump 590 to any desired location. The skim centrifuge 573 and oil centrifuge 586 can be disk-stack centrifuges.

### EXAMPLE

For this example, whole stillage was processed in a similar manner as shown in the configuration of FIG. 2 at a pilot-plant facility. Whole stillage 206 obtained from a dry grind corn ethanol facility was separated with a pressure screen 210 into a filtrate 211 and retentate 208. The whole stillage was processed at a temperature of 185 degrees F., and had a total solids content in the range of 12 to 14% by weight on an as-is basis. The pressure screen was a single bank screen obtained from Fluid Quip, Inc. under the tradename PS-Single pressure screen. The feed pressure of whole stillage provided to the pressure screen was maintained between 65 to 75 psig. The screen size used was 150 microns. The retentate 208 had a total solids content of 18 to 20% by weight on an as-is basis. A portion 236 of centrate 234 in an amount of about 66% by volume was combined with the retentate 208 to form diluted retentate 238. The filtrate 211 had a total solids content of 8 to 10% by weight on an as-is basis.

The diluted retentate was separated with a horizontal decanter as a decanter 230 into a centrate 234 and wet cake 232. The wet cake had a total solids content of 28 to 32%. The decanter centrate 234 had a total solids content of 6 to 8%. The horizontal decanter was a CF6000 model from GEA equipment.

The wet cake was separated with a screw press 250 into a pressate (pressate) 253 and press cake 252. The press cake had a total solids content of 34 to 38%. The screw press was model CP12 & VP12 from Vincent Corporation operated with 100 psig backpressure, and screw speed of 15 rpm. The screw press was operated over 500 hours with no undue screen blinding meaning the screw press had acceptable output and did not need to be stopped to clean.

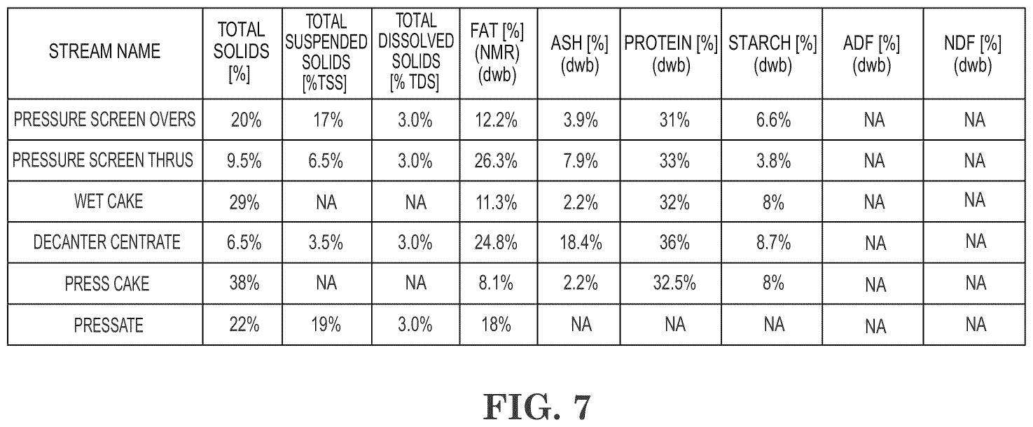

Compositional data for the process streams for one of the trials is shown in FIG. 7. As can be seen, the liquid fractions corresponding to the filtrate 211, decanter centrate 234, and pressate 253 include more fat as compared to the solid fractions corresponding to retentate 208, wet cake 232, and press cake 252, respectively. It is noted that the flow rates among the filtrate 211, decanter centrate 234, and pressate 253 can be different. For example, the flow rates of filtrate 211 and decanter centrate 234 can be relatively higher as compared to the flow rate of pressate 253. With respect to the data for fat, it is also noted that the NMR data reports total fat content, which can include free oil in the liquid phase, if present; oil in oil emulsion; and “trapped oil” within the suspended solids. The thrus, centrate, pressate, and press cake streams were combined to recreate the whole stillage stream for additional testing purposes. For the recombined stream, the fraction of emulsion in the liquid phase increased by 10-20% as measured by both NMR testing and volumetric spin testing.

1. A method of separating plant oil from at least one biorefinery process composition, wherein the method comprises:
separating at least one biorefinery process composition via one or more screen devices into filtrate and retentate, wherein the at least one biorefinery process composition comprises plant oil, wherein at least one of the screen devices comprises a screen having openings with a size of 250 micrometers or less, wherein at least a portion of the at least one biorefinery process composition flows through the openings and forms at least a portion of the filtrate, and wherein the retentate has a total solids content in a range from greater than 15% to less than 25% by weight based on the total weight of retentate on an as-is basis;
separating retentate via one or more solid-liquid separators into a liquid portion and wet cake, wherein the wet cake has a total solids content in a range from 25% to 35% or less by weight based on the total weight of wet cake on an as-is basis;
separating wet cake via one or more presses configured to separate wet cake into pressate and press cake; and
processing at least pressate, wherein the pressate comprises plant oil.

2. The method of claim 1, wherein the at least one biorefinery process composition comprises at least one stillage composition.

3. The method of claim 2, wherein the at least one stillage composition comprises whole stillage derived from distilling beer in a dry-grind corn ethanol process.

4. The method of claim 1, wherein the one or more screen devices are chosen from one or more gravity screens, one or more pressure screens, one or more paddle screens, and combinations thereof.

5. The method of claim 1, wherein the one or more screen devices comprise at least one pressure screen.

6. The method of claim 1, wherein at least one of the screen devices comprises a screen having openings with a size in a range from 125 to 200 micrometers.

7. The method of claim 1, wherein the at least one biorefinery process composition has a total solids content of 15% or less by weight based on the total weight of the at least one biorefinery process composition on an as-is basis.

8. The method of claim 1, further comprising dewatering the at least one biorefinery process composition prior to separating at least one biorefinery process composition via one or more screen devices into filtrate and retentate.

9. The method of claim 1, wherein the at least one biorefinery process composition has a total solids content in a range from 10% to 14% by weight based on the total weight of the at least one biorefinery process composition on an as-is basis.

10. The method of claim 1, wherein the retentate has a total solids content in a range from greater than 16% to 20% by weight based on the total weight of retentate on an as-is basis.

11. The method of claim 1, wherein the one or more solid-liquid separators are chosen from one or more centrifuges, one or more decanters, one or more filters, one or more screen devices, one or more brush strainers, one or more vibratory separators, one or more hydrocyclones, and combinations thereof.

12. The method of claim 1, wherein the liquid portion has a total solids content in a range from greater than 25% to 30% by weight based on the total weight of retentate on an as-is basis.

13. The method of claim 1, wherein each of the filtrate, liquid portion, and pressate are processed to separate plant oil and form a plant oil product.

14. The method of claim 1, wherein the filtrate, liquid portion, and pressate are combined to form a thin stillage, wherein the thin stillage is processed to separate plant oil and form a plant oil product.

15. A biorefinery comprising:
a filtering system configured to separate at least one biorefinery process composition via one or more screen devices into filtrate and retentate, wherein at least one of the screen devices comprises a screen having openings with a size of 250 micrometers or less so that at least a portion of the at least one biorefinery process composition can flow through the openings and form at least a portion of the filtrate;
a separation system in fluid communication with the filtering system and configured to separate retentate via one or more solid-liquid separators into a liquid portion and wet cake; and
a press system in fluid communication with the separation system and configured to separate wet cake via one or more presses into pressate and press cake, wherein the biorefinery is configured to process at least pressate.

16. The biorefinery of claim 15, wherein the one or more presses comprise one or more screw presses, wherein each screw press comprises a rotatable screw disposed within a rigid housing, wherein the rigid housing comprises a plurality of openings, wherein each screw press is configured to rotate the rotatable screw to convey wet cake through the rigid housing under pressure so that wet cake presses against the rigid housing to separate wet cake into pressate and press cake.

17. (canceled)

18. A method of separating plant oil from at least one biorefinery process composition, wherein the method comprises:
separating at least one biorefinery process composition via one or more screen devices into filtrate and retentate, wherein the at least one biorefinery process composition comprises plant oil, wherein at least one of the screen devices comprises a screen having openings with a size of 250 micrometers or less, wherein at least a portion of the at least one biorefinery process composition flows through the openings and forms at least a portion of the filtrate, and wherein the retentate has a total solids content of 35% or less by weight based on the total weight of retentate on an as-is basis;
adding one or more diluents to the retentate to form a diluted retentate;
separating diluted retentate via one or more solid-liquid separators into a liquid portion and wet cake, wherein the wet cake has a total solids content in a range from 25% to 35% or less by weight based on the total weight of wet cake on an as-is basis;
separating wet cake via one or more presses configured to separate wet cake into pressate and press cake; and
processing at least pressate, wherein the pressate comprises plant oil.

19-23. (canceled)

24. The method of claim 18, wherein at least a portion of the diluent comprises thin stillage, distillate, side-stripper bottoms, evaporator condensate, and combinations thereof.

25. The method of claim 18, wherein the diluent is at a temperature from 150° F. to 200° F.

26. A biorefinery comprising:
a filtering system configured to separate at least one biorefinery process composition via one or more screen devices into filtrate and retentate, wherein at least one of the screen devices comprises a screen having openings with a size of 250 micrometers or less so that at least a portion of the at least one biorefinery process composition can flow through the openings and form at least a portion of the filtrate, wherein the biorefinery is configured to add one or more diluents to the retentate to form a diluted retentate;
a separation system in fluid communication with the filtering system and configured to separate diluted retentate via one or more solid-liquid separators into a liquid portion and wet cake; and
a press system in fluid communication with the separation system and configured to separate wet cake via one or more presses into pressate and press cake, wherein the one or more presses comprise a rotatable screw disposed within a rigid housing, wherein the rigid housing comprises a plurality of openings, wherein one or more presses are configured to rotate the rotatable screw to convey wet cake through the rigid housing under pressure so that wet cake presses against the rigid housing to separate wet cake into pressate and press cake, and wherein the biorefinery is configured to process at least pressate.

27. (canceled)
